(19) United States
(12) Patent Application Publication
(10) Pub. No.: US 2011/0244257 A1
(43) Pub. Date: Oct. 6, 2011

(54) METHOD TO REPROCESS POLYLACTIC ACID RESIN AND ARTICLES

(75) Inventors: Claudio M. PAULINO, South Kingstown, RI (US); Mark S. LEE, North Kingstown, RI (US)

(73) Assignee: TORAY PLASTICS (AMERICA), INC., N. Kingstown, RI (US)

(21) Appl. No.: 13/107,149

(22) Filed: May 13, 2011

Related U.S. Application Data
(63) Continuation-in-part of application No. 12/333,047, filed on Dec. 11, 2008.
(60) Provisional application No. 61/334,505, filed on May 13, 2010.
(60) Provisional application No. 60/996,923, filed on Dec. 11, 2007.

(51) Int. Cl. B32B 15/08; B32B 27/00; B32B 27/08; B29C 47/06; C08L 33/08

(52) U.S. Cl. 428/461; 428/500; 428/515; 264/171.1; 525/186

(57) ABSTRACT

Films and formulations that include recycled polylactic acid resin are described. The films and formulations include, for example, 1-10 wt % of an ethylene-acrylate copolymer. The use of the ethylene-acrylate compolymer in the polylactic acid formulations allows for recycling of PLA-based films and articles with minimum degradation, as exhibited by changes in intrinsic viscosity and color properties.

### CROSS-REFERENCE TO RELATED APPLICATIONS

This application claims the benefit of U.S. Provisional Application Ser. No. 61/334,505, filed May 13, 2010, and is a continuation-in-part of U.S. application Ser. No. 12/333,047, filed Dec. 11, 2008, which claims the benefit of U.S. Provisional Application Ser. No. 60/996,923, filed Dec. 11, 2007, the entire contents of which is incorporated herein by reference.

### FIELD OF INVENTION

This invention relates to a novel method to reprocess and recycle polylactic acid polymer without causing degradation of the polymer and without using processes that hydrolyze or reduce the polylactic acid polymer back into its constituent components such as lactides or lactic acid.

### BACKGROUND OF INVENTION

Biaxially oriented polyolefin films are used for packaging, decorative, and label applications and often perform multiple functions. In particular, biaxially oriented polypropylene (BOPP) and biaxially oriented polyethylene (BOPE) films and laminations are popular, high performing, and cost-effective flexible substrates for a variety of snack food packaging applications. In a lamination, they provide printability, transparent or matte appearance, or slip properties. The films sometimes provide a surface suitable for receiving organic or inorganic coatings for gas and moisture barrier properties. The films sometimes provide a heat sealable layer for bag forming and sealing, or a layer that is suitable for receiving an adhesive either by coating or by laminating.

In recent years, interest in “greener” packaging has been developing strongly. Packaging materials based on biologically derived polymers are increasing due to concerns with renewable resources, raw materials, and greenhouse gases. Bio-based polymers are believed—once fully scaled-up—to be able to help reduce reliance on petroleum, reduced production of greenhouse gases. The bio-based polymers can be biodegradable as well. The bio-based polymers polylactic acid (PLA)—which is currently derived from corn starch (but can be derived from other plant sugars) and thus, can be considered to be derived from a renewable resource—is one of the more popular and commercially available materials available for packaging film applications. Other bio-based polymers such as polyhydroxyalkanoates (PHA) and particularly, polyhydroxybutyrate (PHB), are also drawing high interest; however, at the time of this writing, though commercially available, high volume quantities can be limited and costlier than PLA.

Unfortunately, one of the limitations in producing biaxially oriented PLA films (BOPLA) or other PLA articles is the inability or difficulty to use recycled or reclaimed PLA film back into the core layer of new oriented PLA films or PLA articles. In BOPP film manufacturing for example, it is a common practice to take non-conforming or scrap BOPP film, grind it, and re-extrude it in a separate process into pellets. These pellets—made of recycled BOPP film—are then mixed with virgin polypropylene resins and extruded in the BOPP process into new films. By this means, significant cost savings can be achieved, material efficiencies can be improved, and less waste needs to be shipped to landfills.

Although edge trim material is chopped and sent back to the extruder hopper to be mixed with virgin resin in the production of biaxially oriented polylactic acid films as well as polypropylene films, the practice of recycling non-conforming PLA films back into pellets for re-use in the film-making process has been less successful than in polyolefin or polyethylene terephthalate (PET) film production. This is because PLA is highly susceptible to degradation during storage and environmental conditions, particularly with humidity and temperature. Data from Natureworks® LLC for its Ingeo™ brand polylactic acid resins (Natureworks® LLC “Ingeo™ Resin Applications Fundamentals” presentation March 2008) indicate that PLA resin storage at elevated temperatures and humidities can significantly reduce molecular weight through hydrolysis of the resin (FIG. 1). Similar conditions could affect BOPLA films, which would result in poor recycled PLA resin pellets made from films exposed to uncontrolled ambient and/or seasonal conditions of humidity and temperature.

For example, if scrap PLA film meant for recycling back into pellets is stored at ambient conditions with uncontrolled exposure to humidity (e.g. summer time conditions, high humidity climates) the film can absorb moisture--and upon extrusion of such ground-up film into pellets, degradation may occur at extrusion temperatures with such “moist” film due to hydrolysis of the PLA polymer. Upon re-extrusion of such recycled pellets into new film, such degradation could result in gel formation, poor appearance, and poor processability. In contrast, recycled BOPP film pellets are resistant to such hydrolysis effects and do not cause significant degradation issues when re-used in BOPP film production. Thus, the inability to efficiently re-use non-conforming BOPLA film in new BOPLA film production raises the production costs of such films.

It could be possible to store scrap BOPLA film or articles in controlled environmental conditions to reduce moisture absorption and produce acceptable films or articles with a high recycle content. However, this would raise overhead and capital costs, due to the cost of air-conditioning a manufacturing plant or warehouse, which would again result in higher production costs. In addition, another issue could arise in that multiple extrusion passes of the recycled PLA is possible and such repetitive thermal exposures also plays a negative role in the stability of recycled PLA material.

For example, a BOPLA film could be made with 40 wt % recycled BOPLA pellet in its core layer. Waste film from this BOPLA film (due to starting and ending losses at sub-slitting for customer rolls or other downstream processes, non-conforming film, or other reasons) could be remade into new recycled pellets. The original recycled pellets would now be subjected to additional heat histories from not only the original recycling process which made the recycled pellets to begin with, but also from the subsequent film-making run, and then again when such film is recycled yet again into new recycle pellets. These “multiple-extrusion pass heat history” pellets would then be subjected to yet another thermal exposure when re-used into new film. This can continue ad infinitum where at least some portion of the BOPLA film will have been comprised of some amount of multiply-exposed recycled PLA resin pellets which is more and more prone to degradation and hydrolysis. Indeed, as the loading of recycled PLA pellets can vary day-to-day during BOPLA film production due to availability of recycled PLA pellets, this continually degrading amounts of PLA can result in inconsistent processability and quality of the final film product.

U.S. patent application Ser. No. 12/333,047 describes a film composed of a core layer of PLA with a minority component of an ethylene acrylate copolymer to enable high transverse direction orientation rates. This application is wholly incorporated herein by reference.

U.S. Pat. No. 7,128,969 describes a film composed of a base layer of PLA with a minority amount of a thermoplastic or polyolefin such as polypropylene or polyethylene, typically less than 1% by weight of the base layer. Such a formulation is said to be suitable for thermoforming or biaxial stretching by means of pneumatic drawing or other mechanical forming. However, the patent does not contemplate the recyclability of the PLA-based film formulations. In addition, the use of polyolefin additives such as polypropylene or polyethylene will cause incompatibilities with the polylactic acid polymer that can result in a hazy appearance or gels.

EP Patent No. 01385700 describes a biaxially oriented PLA film with good antistatic properties by incorporating antistatic additives such as glycerol monostearate (GMS) into the base layer of PLA. However, this patent's examples do not show or contemplate the ability of such additives to prevent degradation of PLA during recycling or multiple extrusion cycles.

U.S. Pat. No. 7,354,973 describes a polylactic acid composition of 60-97 wt % of PLA and about 3-40 wt % of an ethylene copolymer impact modifier of 20-95 wt % ethylene, 3-70 wt % of an olefin of the formula CH₂═C(R¹)CO₂R² where R¹ is hydrogen or an alkyl group with 1-8 carbon atoms and R² is an alkyl group with 1-8 carbon atoms, and 0.5-25 wt % of an olefin of the formula CH₂═C(R³)CO₂R⁴ where R³ is hydrogen or an alkyl group with 1-6 carbon atoms and R⁴ is glycidyl. This composition was found to be suitable as a toughened composition for injection molding applications to prevent brittleness. Biaxial orientation of films at high orientation rates are not contemplated, nor are multiple cycle extrusions and the effect on PLA degradation.

### SUMMARY OF THE INVENTION

The above issues of making and using recycled PLA pellets from PLA articles, including processing and appearance issues such as gel formulation and film breaks due to the degradation of PLA resins are addressed. A solution that includes using an ethylene-acrylate copolymer as a processing aid is described. The described process and processing aid prevents the degradation of PLA polymers and improves the resistance of PLA to degradation caused by multiple extrusion passes. This processing aid is a polar polymer and thus also has good compatibility with the PLA polymer and results in a clear, highly transparent film.

One embodiment is a biaxially oriented film including a layer including a substantially crystalline PLA resin-containing blend and a sealable amorphous PLA layer. The crystalline PLA resin-containing blend layer could be considered a core or base layer. This PLA base layer includes a blend of crystalline PLA homopolymer combined with an amount of ethylene-acrylate copolymer. The ethylene-acrylate copolymer acts as a processing aid and enables high transverse orientation rates of 8-11× and surprisingly minimizes degradation of the PLA resins during extrusion and particularly during multiple extrusion cycles, thus enabling PLA articles that contain this ethylene-acrylate copolymer to be recycled. Preferably, the core layer includes at least some recycled PLA. The PLA base mono-layer may also include an optional amount of amorphous PLA blended with the crystalline PLA and the ethylene-methacrylate copolymer.

Another embodiment is a multi-layer laminate film including a first layer of a heat sealable resin including an amorphous PLA resin and a second layer including a substantially crystalline PLA resin-containing blend on one side of the sealable amorphous PLA layer. This second crystalline PLA resin-containing blend layer could be considered a core or base layer that provides the bulk strength of the laminate film. The second PLA core layer may be comprised of a blend of crystalline PLA homopolymer combined with an amount of ethylene-acrylate copolymer that acts as a processing aid to enable high transverse orientation rates of 8-11×. This amount of ethylene-acrylate copolymer also surprisingly minimizes degradation of the PLA resins during extrusion and particularly during multiple extrusion cycles, thus enabling PLA articles that contain this ethylene-acrylate copolymer to be recycled. Preferably, the core layer includes at least some recycled PLA. The second PLA core layer may also include an optional amount of amorphous PLA blended with the crystalline PLA and the ethylene-methacrylate copolymer.

The first heat sealable skin layer may be comprised of an amorphous PLA resin which provides heat sealable properties to the laminate and also may include various additives such as antiblock particles to allow for easier film handling.

Furthermore, in another embodiment, the multi-layer laminate could further include a third PLA resin-containing skin layer on the second PLA resin-containing core layer opposite the side with the amorphous PLA sealable layer for use as a printing layer, metal receiving layer, or coating receiving layer. This third layer of this laminate can include an amorphous PLA or a crystalline PLA, or blends thereof.

Preferably, the PLA resin-containing core layer includes a crystalline polylactic acid homopolymer of about 90-100 wt % L-lactic acid units (or 0-10 wt % D-lactic acid units). An optional amount of amorphous PLA may also be blended in with the crystalline PLA from 0-48 wt % of the core layer. The amorphous PLA is also based on L-lactic acid units but has greater than 10 wt % D-lactic acid units and/or meso-lactide units (which includes one each of L and D lactic acid residuals). The ethylene-acrylate copolymer component of the core layer formulation is from about 1-10 wt % of the core layer. If no other skin layers are coextruded with the core layer, or if the third skin layer is not coextruded with the core layer, it is also contemplated to add to the core layer antiblock particles of suitable size, for example, amorphous silicas, aluminosilicates, sodium calcium aluminum silicates, crosslinked silicone polymers, and polymethylmethacrylates to aid in machinability and winding. Suitable amounts range from 0.03-0.5% by weight of the core layer and typical particle sizes of 3.0-6.0 μm in diameter. Migratory slip additives may also be utilized to control COF properties such as fatty amides (e.g. erucamide, stearamide, oleamide, etc.) or silicone oils ranging from low molecular weight oils to ultra high molecular weight gels. Suitable amounts of slip additives to use can range from 300 ppm to 10,000 ppm of the layer.

Preferably, the first PLA heat sealable resin-containing skin layer includes an amorphous PLA of greater than 10 wt % D-lactic acid units. It is not necessary to use any of the ethylene-acrylate copolymer in this case, as the amorphous PLA can be oriented relatively easily and the amount of ethylene-acrylate copolymer in the core layer is sufficient to prevent degradation of the heat sealable amorphous PLA skin layer during recycling (however, if desired, an amount of ethylene-acrylate copolymer may be optionally added to this heat sealable skin layer in an amount of about 1-10 wt % of the skin layer). This first heat sealable amorphous PLA resin-containing layer can also include an antiblock, for example, amorphous silicas, aluminosilicates, sodium calcium aluminum silicates, crosslinked silicone polymers, and polymethylmethacrylates to aid in machinability and winding and to lower coefficient of friction (COF) properties. Suitable amounts range from 0.03-0.5% by weight of the core layer and typical particle sizes of 3.0-6.0 μm in diameter, depending on the final thickness of this layer. Migratory slip additives may also be utilized to control COF properties such as fatty amides (e.g. erucamide, stearamide, oleamide, etc.) or silicone oils ranging from low molecular weight oils to ultra high molecular weight gels. Suitable amounts of slip additives to use can range from 300 ppm to 10,000 ppm of the layer.

In an alternative embodiment the first PLA resin-containing skin layer may include a non-heat-sealable amorphous PLA such as a crystalline PLA resin similar to that used in the second PLA resin-containing core layer. In addition, various blends of amorphous and crystalline PLA can be utilized at similar ratios as described with respect to the core layer. In the case that a crystalline PLA is used or a blend including crystalline PLA, an amount of the ethylene-acrylate copolymer process aid could optionally be used—again preferably in an amount of 1-10 wt % of this layer to enable transverse orientation at high rates and to enable good recyclability with little degradation. (However, the amount of ethylene-acrylate copolymer used in the core layer is typically sufficient to protect the skin layer from degradation during recycling.) Preferably, this layer will also contain antiblock particles, for example, amorphous silicas, aluminosilicates, sodium calcium aluminum silicates, crosslinked silicone polymers, and polymethylmethacrylates to aid in machinability and winding. Suitable amounts range from 0.03-0.5% by weight of the core layer and may have typical particle sizes of 3.0-6.0 μm in diameter, depending on the final thickness of this layer. Migratory slip additives may also be utilized to control COF properties such as fatty amides (e.g. erucamide, stearamide, oleamide, etc.) or silicone oils ranging from low molecular weight oils to ultra high molecular weight gels, or blends of fatty amides and silicone oil-based materials. Suitable amounts of slip additives to use can range from 300 ppm to 10,000 ppm of the layer.

Preferably, the optional third PLA resin-containing layer includes an amorphous PLA, a crystalline PLA, or blends thereof. In the case where crystalline PLA is employed, an amount of the ethylene-acrylate copolymer process aid could be used, again in the amount of 1-10 wt % of this layer to aid in enabling high transverse orientation rates and to enable recyclability with little degradation. (However, the amount of ethylene-acrylate copolymer used in the core layer is typically sufficient to protect the skin layer from degradation during recycling.) Preferably, this layer also contains antiblock particles selected from the group consisting of amorphous silicas, aluminosilicates, sodium calcium aluminum silicates, crosslinked silicone polymers, and polymethylmethacrylates to aid in machinability and winding. Suitable amounts range from 0.03-0.5% by weight of the core layer and typical particle sizes of 3.0-6.0 μm in diameter, depending on the final thickness of this layer. Preferably, the third polyolefin layer is a discharge-treated layer having a surface for lamination, metallizing, printing, or coating with adhesives or inks.

In the case where the above embodiments are to be used as a substrate for vacuum deposition of a metal layer, it is recommended that migratory slip additives not be used as these types of materials may adversely affect the metal adhesion or metallized gas barrier properties of the metallized BOPLA film. It is thought that as the hot metal vapor condenses on the film substrate, such fatty amides or silicone oils on the surface of the film vaporize and cause pin-holing of the metal-deposited layer, thus compromising gas barrier properties. Thus, only non-migratory antiblock materials should be used to control COF and web-handling.

In the case where the above embodiments are to be used as a printing film, it may be advisable to avoid the use of silicone oils, in particular low molecular weight oils, as these may interfere with the print quality of certain ink systems used in process printing applications. However, this depends greatly upon the ink system and printing process used.

An embodiment of a film may include a base layer including recycled polylactic acid resin and at least 1 wt % ethylene acrylate copolymer. Preferably, the film or the base layer contains at least 1 wt % recycled polylactic acid resin, more preferably at least 5 wt %. An embodiment of a laminate film may include a base layer including recycled polylactic acid resin and at least 1 wt % ethylene acrylate copolymer, and a heat sealable layer including amorphous polylactic acid on a surface of the base layer. Preferably, the laminate film or the base layer contains at least 1 wt % recycled polylactic acid resin, more preferably at least 5 wt %.

An article may include recycled polylactic acid resin and at least 1 wt % ethylene acrylate copolymer. A resin mixture may include a recycled polylactic acid resin and at least 1 wt % ethylene acrylate copolymer. Preferably, the article and the resin mixture contain at least 1 wt %, more preferably at least 5 wt %, recycled polylactic acid resin.

A method of making a film may include extruding a film including a base layer including recycled polylactic acid resin and at least 1 wt % ethylene acrylate copolymer. The method may further include recycling scrap material from the film, and re-extruding a layer including the recycled scrap material.

A method of making a multilayer film may include co-extruding a multilayer film including a base layer and a heat sealable layer on a surface of the base layer, the base layer comprising recycled polylactic acid resin and at least 1 wt % ethylene acrylate copolymer, and the heat sealable layer comprising amorphous polylactic acid. The method may further include recycling scrap material from the multi-layer film; and re-extruding a film comprising the recycled scrap material.

For the above describe multi-layer film structures, it is preferable to discharge-treat the side of this multi-layer film structure opposite the heat sealable first layer for lamination, metallizing, printing, or coating. In the embodiment of a single layer monoweb film, it is preferable to discharge-treat one or both sides of the crystalline PLA-containing base layer. In the case of a 2-layer laminate structure wherein the amorphous PLA sealable layer is contiguous with a crystalline PLA-containing core layer, it is preferable to discharge-treat the side of the core layer opposite the sealable layer for purposes of laminating, printing, metallizing, coating, etc. In the case of a 3-layer laminate structure, it is preferable to discharge-treat the side of the third layer which is contiguous to the side of the core layer opposite the heat sealable first layer. This third layer, as mentioned previously, is often formulated with materials that are conducive to receiving printing inks, metallizing, adhesives, or coatings.

Discharge-treatment in the above embodiments can be accomplished by several means, including but not limited to corona, flame, plasma, or corona in a controlled atmosphere of selected gases. Preferably, in one variation, the discharge-treated surface has a corona discharge-treated surface formed in an atmosphere of CO₂ and N₂ to the exclusion of O₂. The laminate film embodiments could further include a vacuum-deposited metal layer on the discharge-treated layer's surface. Preferably, the metal layer has a thickness of about 5 to 100 nm, has an optical density of about 1.5 to 5.0, and includes aluminum, although other metals can be contemplated such as titanium, vanadium, chromium, manganese, iron, cobalt, nickel, copper, zinc, gold, or palladium, or alloys or blends thereof.

Preferably, the laminate film is produced via coextrusion of the heat sealable layer and the blended core layer and other layers if desired, through a compositing die whereupon the molten multilayer film structure is quenched upon a chilled casting roll system or casting roll and water bath system and subsequently oriented in the machine and/or transverse direction into an oriented multi-layer film. Machine direction orientation rate is typically 2.0-3.0× and transverse direction orientation—with the use of the ethylene-acrylate impact modifier process aid—is typically 8.0-11.0×. Heat setting conditions in the TDO oven is also critical to minimize thermal shrinkage effects.

All these examples can also be metallized via vapor-deposition, preferably a vapor-deposited aluminum layer, with an optical density of at least about 1.5, preferably with an optical density of about 2.0 to 4.0, and even more preferably between 2.3 and 3.2. Optionally, an additional third layer specifically formulated for metallizing to provide adequate metal adhesion, metal gloss, and gas barrier properties can be disposed on the second PLA resin-containing core layer, opposite the side with the heat sealable layer. This additional layer's surface may also be modified with a discharge treatment to make it suitable for metallizing, laminating, printing, or converter applied adhesives or other coatings.

The BOPLA films may be oriented in the transverse direction at high orientation rates in excess of 6 TDX (transverse direction orientation rate) and typically in the range of 8-11 TDX, similar to BOPP transverse direction orientation rates. This is significantly higher than what has been previously achieved with BOPLA films. Such a film composition can result in biaxially oriented PLA films that are more economical than the current art for BOPLA and can enable the use of BOPP assets to make BOPLA films without significant capital expense and modifications.

In addition, the use of ethylene-acrylate copolymers in an amount of about 1-10 wt % of the core or base layer (and optionally in the coextruded skin layers of multi-layer laminate film embodiments) has shown significant improvement in minimizing degradation of PLA during recycling operations involving multiple extrusion cycles. Such improvement is shown via retention of intrinsic viscosity and color lightness (L*a*b* color scale) which, in turn, indicates that the molecular weight of the PLA resin is maintained.

Additional advantages of this invention will become readily apparent to those skilled in the art from the following detailed description, wherein only the preferred embodiments of this invention is shown and described, simply by way of illustration of the best mode contemplated for carrying out this invention. As will be realized, this invention is capable of other and different embodiments, and its details are capable of modifications in various obvious respects, all without departing from this invention. Accordingly, the examples and description are to be regarded as illustrative in nature and not as restrictive.

### BRIEF DESCRIPTION OF THE DRAWINGS

FIG. 1 is a graph showing the molecular weight loss for the amorphous PLA Ingeo™ made by Natureworks® LLC at aggressive temperatures and humidities.

FIG. 2 is a transmission microscopy image of a cast film including crystalline PLA and ethylene-acrylate copolymer dry-blended together and shows that the ethylene-acrylate copolymer exists as domains within the PLA.

FIG. 3 is a drawing of an ethylene-acrylate copolymer forming a quasi-network between the acrylate groups and PLA.

FIG. 4A is a graph that compares the intrinsic viscosity of pellets made according to Example 1 to pellets made according to Comparative Example 1 after 5-passes.

FIG. 4B is a graph that compares the color lightness (L) of pellets made according to Example 1 to pellets made according to Comparative Example 1 after 5 passes.

FIG. 4C is a graph that compares the color a, b of pellets made according to Example 1 to pellets made according to Comparative Example 1 after 5-passes.

FIG. 5A is a graph that compares the intrinsic viscosity of pellets made according to Comparative Example 2, Example 2, Example 3, and Example 4 after 5-passes.

FIG. 5B is a graph that compares the color lightness (L) of pellets made according to Comparative Example 2, Example 2, Example 3, and Example 4 after 5-passes.

FIG. 5C is a graph that compares the color a, b of pellets made according to Comparative Example 2, Example 2, Example 3, and Example 4 after 5-passes.

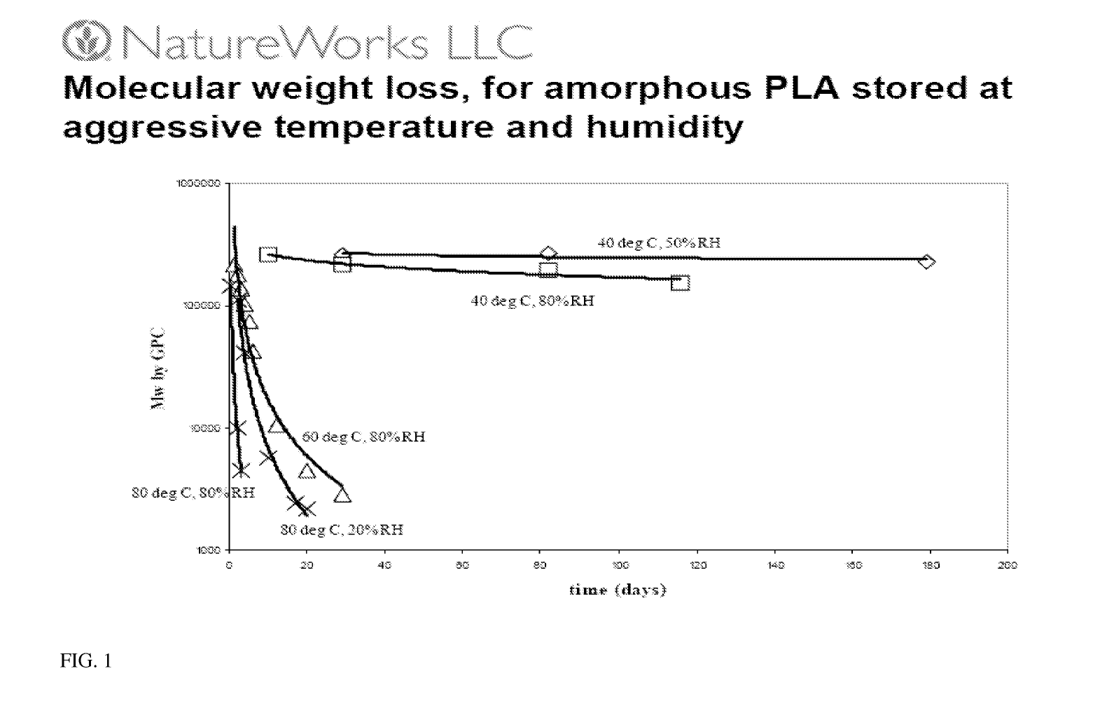

### DETAILED DESCRIPTION OF THE INVENTION

Described are methods to reprocess and recycle polylactic acid polymer without causing degradation of the polymer and without using processes that hydrolyze or reduce the polylactic acid polymer back into its constituent components such as lactides or lactic acid. This allows the recycling of polylactic acid articles, for example, formed or oriented films. The oriented films may be reground and repelletized into new polylactic acid pellets without degradation and can be re-used as a component of the production of new polylactic acid articles or films. Producing stable PLA recycle pellets can significantly improve processability, productivity, and cost of BOPLA films without causing processability, quality, or appearance of the BOPLA film which uses such recycled PLA pellets. Also described are oriented films made from recycled polylactic polymer.

One embodiment is a film that includes a single extruded mixed PLA resin core layer. This mixed PLA resin core layer includes a crystalline polylactic acid polymer optionally blended with an amount of an amorphous PLA polymer, and an amount of ethylene-acrylate copolymer. One or both sides of the crystalline PLA-containing core layer may be discharge-treated in order to provide further functionality as a surface to receive metallization, printing, coating, or laminating adhesives.

In another embodiment, the laminate film includes a 2-layer coextruded film. The 2-layer coextruded film may include a mixed PLA resin core layer including a crystalline polylactic acid polymer optionally blended with an amount of an amorphous PLA polymer, and an amount of ethylene-acrylate copolymer; and a heat sealable layer including an amorphous polylactic acid polymer. The side of the crystalline PLA core layer blend opposite the sealable resin layer may be discharge-treated.

In yet another embodiment, the laminate film includes a similar construction as above, except that a third PLA skin layer is disposed on the side of the crystalline PLA layer blend opposite the heat sealable amorphous PLA layer. This third PLA layer can include either crystalline PLA resin or amorphous PLA resin or blends thereof. In the case where crystalline PLA resin is part of this layer's formulation, an amount of ethylene-acrylate copolymer may be incorporated into the layer as in the core layer formulation. Generally, it is desirable to discharge-treat the exposed surface of this third layer in order to provide further functionality as a surface to receive metallization, printing, coating, or laminating adhesives. Further embodiments may be contemplated in which additional layers may be interposed between the core layer and the outermost skin layers.

The polylactic acid resin core layer is preferably a crystalline polylactic acid of a specific optical isomer content and can be biaxially oriented. As described in U.S. Pat. No. 6,005,068, lactic acid has two optical isomers: L-lactic acid (also known as (S)-lactic acid) and D-lactic acid (also known as (R)-lactic acid). Three forms of lactide can be derived from these lactic acid isomers: L,L-lactide (also known as L-lactide) and which includes two L-lactic acid residuals; D,D-lactide (also known as D-lactide) and which includes two D-lactic acid residuals; and meso-lactide which includes one each of L and D-lactic acid residuals. The degree of crystallinity is determined by relatively long sequences of a particular residual, either long sequences of L or of D-lactic acid. The length of interrupting sequences is important for establishing the degree of crystallinity (or amorphous) and other polymer features such as crystallization rate, melting point, or melt processability.

The crystalline polylactic acid resin is preferably one comprised primarily of the L-lactide isomer with minority amounts of either D-lactide or meso-lactide or combinations of D-lactide and meso-lactide. Preferably, the minority amount is D-lactide and the amount of D-lactide is 10 wt % or less of the crystalline PLA polymer. More preferably, the amount of D-lactide is less than about 5 wt %, and even more preferably, less than about 2 wt %. Suitable examples of crystalline PLA for this invention are Natureworks® Ingeo™ 4042D and 4032D. These resins have relative viscosity of about 3.9-4.1, a melting point of about 165-173° C., a crystallization temperature of about 100-120° C., a glass transition temperature of about 55-62° C., a D-lactide content of about 4.25 wt % and 1.40 wt % respectively, density of about 1.25 g/cm³, and a maximum residual lactide in the polylactide polymer of about 0.30% as determined by gas chromatography. Molecular weight M_{w} is typically about 200,000; Mₙ typically about 100,000; polydispersity about 2.0. Natureworks® 4032D is the more preferred crystalline PLA resin, being more crystalline than 4042D and more suitable for high heat biaxial orientation conditions. In addition, the 4042D PLA grade contains about 1000ppm of erucamide and for some applications, particularly for gas barrier metallizing, may not be suitable.

The core resin layer is typically 8 μm to 100 μm in thickness after biaxial orientation, preferably between 10 μm and 50 μm, and more preferably between about 15 μm and 25 μm in thickness.

The core layer can also optionally include an amount of amorphous PLA resin to improve further extrusion processing and oriented film processing. The addition of amorphous PLA in the core layer helps to lower extrusion polymer pressure and in terms of film manufacturing, helps to reduce or slow the crystallization rate of the newly oriented film. This aids in the orientation of the PLA film in both machine direction (MD) and transverse direction (TD) and helps reduce defects such as uneven stretch marks. It also helps with the slitting of the biaxially oriented film at the edge-trimming section of the line by reducing the brittleness of the edge trim and reducing the instances of edge trim breaks which can be an obstacle to good productivity. The amorphous PLA is preferably based on a L-lactide isomer with D-lactide content of greater than 10 wt %. A suitable amorphous PLA to use is Natureworks® Ingeo™ 4060D grade. This resin has a relative viscosity of about 3.25-3.75, T_{g} of about 52-58° C., seal initiation temperature of about 80° C., density of about 1.24 g/cm³, a D-lactide content of about 12 wt %, and a maximum residual lactide in the polylactide polymer of about 0.30% as determined by gas chromatography. Molecular weight M_{w} is about 180,000. Suitable amounts of amorphous PLA to use in the core are concentrations of up to about 48 wt % of the core layer, preferably up to about 30 wt % of the core layer, and even more preferably about 15 wt % of the core layer. It should be noted, however, that too much amorphous PLA in the core layer (e.g. 50% or greater) can cause high thermal shrinkage rates after biaxial orientation and in spite of heat-setting conditions in the transverse orientation oven to make a thermally stable film. A thermally, dimensionally stable film is important if the substrate is to be used as a metallizing, printing, coating, or laminating substrate. (However, if the BOPLA is desired as a shrinkable film, this composition and appropriate processing conditions might be suitable.)

Ethylene-acrylate copolymer is blended into at least the core layer in a minority amount to minimize degradation of the PLA-based film article during recycling or multiple extrusion cycles. Ethylene-acrylates are of the general chemical formula of CH₂═C(R¹)CO₂R² where R¹ can be hydrogen or an alkyl group of 1-8 carbon atoms and R² is an alkyl group of 1-8 carbon atoms. Ethylene-acrylate copolymers contemplated for this invention can be based on ethylene-acrylate, ethylene-methacrylate, ethylene-n-butyl acrylate-glycidyl methacrylate, ethylene-glycidyl methacrylate, ethylene-butyl-acrylate, ethylene acrylic esters, or blends thereof. Ethylene vinyl acetate (EVA) and ethylene methacrylate (EMA) can also be contemplated. Other similar materials may also be contemplated. As described in U.S. Pat. No. 7,354,973, suitable compositions of the ethylene-acrylate copolymers can be about 20-95 wt % ethylene content copolymerized with about 3-70 wt % n-butyl acrylate and about 0.5-25 wt % glycidyl methacrylate monomers. A particularly suitable ethylene-acrylate copolymer of this type is one produced by E. I. DuPont de Nemours and Company Packaging and Industrial Polymers Biomax® Strong 120. This additive has a density of about 0.94 g/cm³, a melt flow rate of about 12 g/10 minutes at 190° C./2.16 kg weight, a melting point of about 72° C., and a glass transition temperature of about −55° C. Other suitable ethylene-acrylate copolymer impact modifiers commercially available are: DuPont Elvaloy® PTW, Rohm & Haas, Inc. BPM500, and Arkema, Inc. Biostrength® 130.

Suitable amounts of ethylene-acrylate copolymer to be blended in the crystalline PLA-containing core layer is from 1-10 wt % of the core layer, preferably 2-7 wt % and more preferably, 3-5 wt %. At these concentrations, acceptable clarity of the biaxially oriented film is maintained. Too much ethylene-acrylate may cause haziness; too little may not provide enough protection to minimize degradation. Blending into the core layer can be done most economically by dry-blending the respective resin pellets; it is contemplated that more aggressive blending such as melt-compounding via single-screw or twin-screw can result in better dispersion of the ethylene-acrylate copolymer throughout the PLA matrix.

In the embodiments of a single-layer film or a 2-layer coextruded multilayer film, the core resin layer can be surface-treated on one side. In the case of a 2-layer coextruded film, the side opposite the skin layer can be surface-treated. Surface treatment can be accomplished with an electrical corona-discharge treatment method, flame treatment, atmospheric plasma treated, or corona discharge treated in a controlled atmosphere of nitrogen, carbon dioxide, or a mixture thereof, with oxygen excluded and its presence minimized. The latter method of corona treatment in a controlled atmosphere of a mixture of nitrogen and carbon dioxide is particularly preferred. This method results in a treated surface that includes nitrogen-bearing functional groups, preferably at least 0.3 atomic % or more, and more preferably, at least 0.5 atomic % or more. This treated core layer surface is then well suited for subsequent purposes of metallizing, printing, coating, or laminating.

In embodiments of a single-layer or 2-layer laminate film, it is often desirable to add an optional amount of antiblocking agent to the core layer for aiding machinability and winding. An amount of an inorganic antiblock agent can be added in the amount of 100-1000 ppm of the core resin layer, preferably 300-600 ppm. Preferred types of antiblock are spherical sodium aluminum calcium silicates or an amorphous silica of nominal 6 μm average particle diameter, but other suitable spherical inorganic antiblocks can be used including crosslinked silicone polymer or polymethylmethacrylate, and ranging in size from 2 μm to 6 μm. Migratory slip agents such as fatty amides and/or silicone oils can also be optionally employed in the core layer either with or without the inorganic antiblocking additives to aid further with controlling coefficient of friction and web handling issues. Suitable types of fatty amides are those such as stearamide or erucamide and similar types, in amounts of 100-1000 ppm of the core. Preferably, stearamide is used at 400-600 ppm of the core layer. A suitable silicone oil that can be used is a low molecular weight oil of 350 centistokes which blooms to the surface readily at a loading of 400-600 ppm of the core layer. However, if the films of this invention are desired to be used for metallizing or high definition process printing, it is recommended that the use of migratory slip additives be avoided in order to maintain metallized barrier properties and adhesion or to maintain high printing quality in terms of ink adhesion and reduced ink dot gain.

In some embodiments, the core or base PLA layer can be cavitated using known inorganic or polymeric cavitating agents and biaxially orienting the mixture. Such cavitation typically renders the film opaque and/or white in appearance which can be a desirable attribute in some applications. Cavitating agents can be inorganic ones including but not limited to: talcs, titanium dioxides, calcium carbonates, silicas, silicates, crosslinked silicone polymer particles, barium sulfates, and blends thereof. Organic cavitating agents that can be used include (but not limited to): cyclic olefin copolymers, polystyrenes, polymethylmethacrylates, polybutylene terephthalates, polycarbonates, or blends thereof. Typical loadings of cavitating agents in the core or base layer can be in the amount of 0.5 wt % to 15 wt %, preferably 5-10 wt %. Particle sizes for the cavitating agents can be about 0.5 to 6 μm in nominal diameter, and preferably 1.0-3.0 μm. Whitening pigments such as titanium oxide or barium sulfate can be added in addition to the cavitating agent for brighter whiteness. Another effect of cavitating the PLA articles or films is that the voided structure will have a lower density than a non-cavitated PLA article; such lower density can help provide reduced cost, particularly in film packaging applications.

The coextruded skin layer can be a heat sealable resin layer that includes an amorphous polylactic acid polymer and can optionally include an amount of the ethylene-acrylate copolymer additive, in an amount of about 1-10 wt %, preferably 2-7 wt %, and more preferably, 3-5 wt %, of the skin layer. As described above, the amorphous PLA is preferably based on a L-lactide isomer with D-lactide content of greater than 10 wt %. A suitable amorphous PLA to use is Natureworks® Ingeo™ 4060D grade. This resin has a relative viscosity of about 3.25-3.75, T_{g} of about 52-58° C., seal initiation temperature of about 80° C., density of about 1.24 g/cm³, a D-lactide content of about 12 wt %, and a maximum residual lactide in the polylactide polymer of about 0.30% as determined by gas chromatography. The Molecular weight M_{w} of this amorphous PLA is about 180,000. The preferred amount to be used as a heat sealable skin layer is about 100 wt % of the layer. It is also preferred to add an amount of inorganic antiblock to this layer to aid in web-handling, COF control, film winding, and static control, among other properties. Suitable amounts include about 1000-5000 ppm of the heat sealable resin layer, preferably 3000-5000 ppm.

Preferred types of antiblock are spherical crosslinked silicone polymer such as Momentive Specialty Chemical's Tospearl® grades of polymethlysilsesquioxane of nominal 2.0 and 3.0 μm sizes. Alternatively, sodium aluminum calcium silicates of nominal 3 μm in diameter can also be used (such as Mizusawa Silton® JC-30), but other suitable spherical inorganic antiblocks can be used including polymethylmethacrylate, silicas, and silicates, and ranging in size from 2 μm to 6 μm. Migratory slip agents such as fatty amides or silicone oils can also be optionally added to the heat seal resin layer of types and quantities mentioned previously if lower COF is desired. However, if the films of this invention are desired to be used for metallizing or high definition process printing, it is recommended that the use of migratory slip additives be avoided or minimized in order to maintain metallized barrier properties and metal adhesion or to maintain high printing quality in terms of ink adhesion and reduced ink dot gain.

The heat sealable resin layer can be coextruded on one side of the core layer, the heat sealable layer having a thickness after biaxial orientation of between 0.5 and 5 μm, preferably between 1.0 and 2.0 μm. The core layer thickness can be of any desired thickness after biaxial orientation, but preferred and useful thicknesses are in the range of 10 μm to 100 μm, preferably 13.5 μm to 25 μm, and even more preferably 15.0 μm-20.0 μm. The coextrusion process includes a multi-layered compositing die, such as a two- or three-layer die. In the case of a 2-layer coextruded film, a two-layer compositing die can be used. In the case of a 3-layer coextruded film, the polymer blend core layer can be sandwiched between the heat sealable resin layer and a third layer using a three-layer compositing die.

One embodiment is to coextrude only two layers, the blended core layer and the heat sealable layer coextruded on one side of the core layer. In this embodiment, the core layer side opposite the heat sealable layer can be further modified by adding inorganic antiblock particles into the core layer itself and can also be surface-treated via a discharge-treatment method if so desired. In a three-layer coextruded film embodiment, the third layer on the side of the core layer opposite the heat sealable layer can also be modified with antiblock particles in lieu of the core layer and also be surface-treated via a discharge-treatment method as desired. The third layer can include any polymer typically compatible with the core layer resin such as a crystalline PLA resin, amorphous PLA resin, or blends thereof. Typically, selection of this third layer's formulation is to enhance the coextruded film's printability, appearance, metallizability, winding, laminating, sealability, or other useful characteristics. Useful thickness of this third layer after biaxial orientation can be similar to the thicknesses cited for the heat sealable skin layer, namely, preferably 1.0-2.0 μm.

The surface opposite the heat sealable layer can be surface-treated if desired with a corona-discharge method, flame treatment, atmospheric plasma, or corona discharge in a controlled atmosphere of nitrogen, carbon dioxide, or a mixture thereof which excludes oxygen. The latter treatment method in a mixture of CO₂ and N₂ only is preferred. This method of discharge treatment results in a treated surface that includes nitrogen-bearing functional groups, preferably 0.3% or more nitrogen in atomic %, and more preferably 0.5% or more nitrogen in atomic %. This discharge-treated surface can then be metallized, printed, coated, or extrusion or adhesive laminated. Preferably, it is printed or metallized, and more preferably, metallized.

If a three-layer coextruded film embodiment is chosen, a third layer may be coextruded with the core layer opposite the heat sealable resin layer, having a thickness after biaxial orientation between 0.5 and 5 μm, preferably between 0.5 and 3 μm, and more preferably between 1.0 and 2.0 μm. A suitable material for this layer is a crystalline PLA or amorphous PLA or blends thereof, as described earlier in the description. If amorphous PLA is used, the same suitable resin grade used for the heat sealable layer may be employed (e.g. Natureworks® 4060D). If crystalline PLA is used, the same suitable grades as used for the core layer may be employed such as Natureworks® 4042D or 4032D, with the 4032D grade preferred in general.

Additionally, blends of both crystalline and amorphous PLA may be contemplated for this layer, similar to previously described formulations for the core layer, but not limited to those descriptions. For example, the ratio of amorphous PLA to crystalline PLA for this third skin layer can range from 0-100 wt % amorphous PLA and 100-0 wt % crystalline PLA. In those embodiments in which crystalline PLA is used in the third layer, an amount of ethylene-acrylate copolymer can be optionally added as described previously. Suitable amounts of ethylene-acrylate copolymer to use in this skin layer are 1-10 wt %, preferably 2-7 wt % and, more preferably, 3-5 wt %. The use of various blends of amorphous and crystalline PLA in this layer may make it more suitable for printing, metallizing, coating, or laminating, and the exact ratio of the blend can be optimized for these different applications.

This third layer may also advantageously contain an anti-blocking agent and/or slip additives for good machinability and a low coefficient of friction in about 0.01-0.5% by weight of the third layer, preferably about 250-1000 ppm. Preferably, non-migratory inorganic slip and/or antiblock additives as described previously should be used to maintain gas barrier properties and metal adhesion if metallizing, or ink wetting and ink adhesion if printing.

In addition, another embodiment that can be considered is to replace the heat sealable amorphous PLA layer with a non-sealable PLA layer. In this variation, amorphous or crystalline PLA may be used, or blends thereof. In the case of making this layer non-sealable, preferably crystalline PLA should be used, either by itself or as the majority component of a blend with amorphous PLA. As discussed previously, if crystalline PLA is used for this layer, an amount of ethylene-acrylate copolymer can be optionally added as part of this layer. Suitable amounts of ethylene-acrylate copolymer to use in this skin layer are 1-10 wt %, preferably 2-7 wt % and, more preferably, 3-5 wt %. Preferably, non-migratory inorganic slip and/or antiblock additives as described previously should be used to maintain gas barrier properties and metal adhesion if metallizing, or ink wetting and ink adhesion if printing. It is also preferred to add an amount of inorganic antiblock to this layer to aid in web-handling, COF control, film winding, and static control, among other properties. Suitable amounts would be about 1000-5000 ppm of the this non-eat sealable resin layer, preferably 3000-5000 ppm. Preferred types of antiblock are spherical crosslinked silicone polymer such as Momentive Specialty Chemical's Tospearl® grades of polymethlysilsesquioxane of nominal 2.0 and 3.0 μm sizes. Alternatively, sodium aluminum calcium silicates of nominal 3 μm in diameter can also be used (such as Mizusawa Silton® JC-30), but other suitable spherical inorganic antiblocks can be used including polymethylmethacrylate, silicas, and silicates, and ranging in size from 2 μm to 6 μm. It is often preferred to discharge-treat the exposed side of this layer so as to enable adequate adhesion and wet-out of adhesives or inks or coatings to this side. In particular, cold seal latexes can be applied to this discharge-treated surface.

The multilayer coextruded film of the invention can be made either by sequential biaxial orientation or simultaneous biaxial orientation, which are well-known processes in the art. The multilayer coextruded laminate sheet may be coextruded at melt temperatures of about 190° C. to 215° C. and cast and pinned—using electrostatic pinning—onto a cooling drum whose surface temperature is controlled between 15° C. and 26° C. to solidify the non-oriented laminate sheet at a casting speed of about 6 mpm. If sequential biaxial orientation is used, the non-oriented laminate sheet may be stretched first in the longitudinal direction at about 40° C. to 65° C. at a stretching ratio of about 2 to about 4 times the original length, preferably about 3.0 times, using differentially heated and sped rollers and the resulting stretched sheet may be heat-set at about 40-45° C. on annealing rollers and cooled at about 25-40° C. on cooling rollers to obtain a uniaxially oriented laminate sheet. The uniaxially oriented laminate sheet may then be introduced into a tenter at a line speed of about 18-50 mpm, preliminarily heated between 65° C. and 75° C., stretched in the transverse direction at a temperature of about 75-105° C. and at a stretching ratio of about 4 to about 12 times, preferably 4-8 times, and more preferably about 4.-6 times the original width, and then heat-set or annealed at about 90-145° C., and preferably 90-95° C., to reduce internal stresses due to the orientation and minimize shrinkage and give a relatively thermally stable biaxially oriented sheet. TD orientation rates may be adjusted by moving the transverse direction rails in or out per specified increments.

The biaxially oriented film may have a total thickness between 10 and 100 μm, preferably between 15 and 30 μm, and most preferably between 20 and 25 μm. For simultaneous orientation, the machine direction and transverse direction stretching may be done simultaneously using a specially designed tenter-frame and clip and chain design which obviates the need for a machine direction orienter of driven and heated rollers.

The films and articles of interest made with the above-described embodiments and formulations may be ground into flakes using sheet grinders such as made by Hosakawa Alpine Polymer Systems (Berlin, Conn., USA) model 1626, 100 hp, 115 A, with a knife gap of 0.006 inches (0.1524 mm) and a screen size of 0.25 inches (6.35 mm). Flake density produced by this process may be about 7 lb/ft³ (0.112 g/cm³). Flake may then be processed into pellets using single or twin-screw extrusion using a Leistritz 34 mm counter-rotating, vacuum-vented extruder at a extrusion temperature set-points of about 175-210° C. via processes well-known in the art. Intrinsic viscosity (IV) and color of the resulting pellets may then be measured. These pellets may then be reprocessed again through the twin-screw extruder and re-pelletized. This process may be repeated, for example, up to five times, thus exposing the PLA resin blend to at least five extrusion cycles and heat histories. The intrinsic viscosity and color of the resulting pellets may be measured after each extrusion cycle.

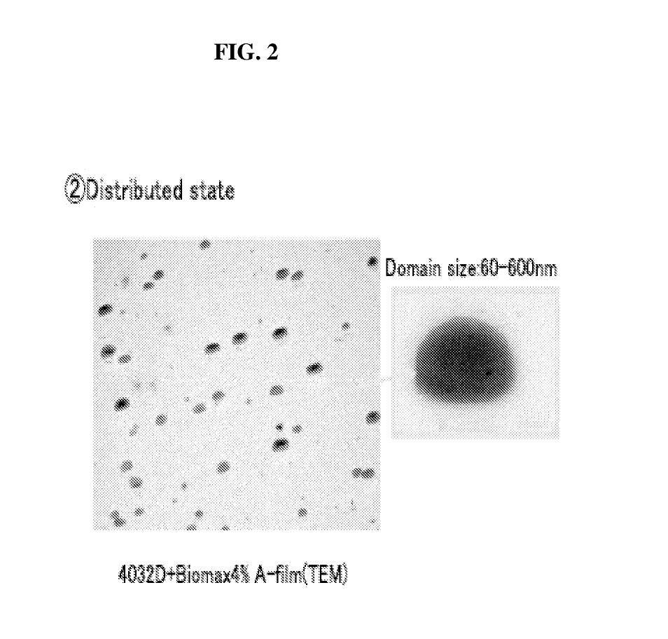

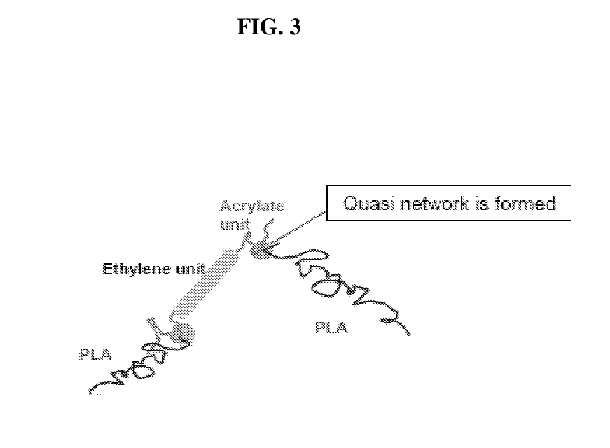

As illustrated in FIG. 2, transmission microscopy of cast films including crystalline PLA and ethylene-acrylate copolymer dry-blended together shows that the ethylene-acrylate copolymer exists as domains within the PLA; the domain size ranges from 60-600 nm. The domain size may be made smaller and better dispersed if melt-compounding by single or twin-screw processes is used to blend the PLA and ethylene-acrylate together. Without being bound by any theory, one hypothesis for the mechanism for ethylene-acrylate to reduce orientation stresses as well as help prevent degradation is that the ethylene-acrylate copolymer forms a quasi-network between the acrylate groups and the polylactic acid polymer chains as shown in FIG. 3. This new structure appears to be less susceptible to thermal and hydrolytic degradation than the original unmodified PLA polymer chains. In addition, the ethylene-acrylate copolymer's ethylene units may provide a lubricating function, reducing frictional heat between PLA molecules during extrusion cycles, thus decreasing degradation.

Further embodiments can include metallizing the discharge-treated surface opposite the heat sealable resin layer. The unmetallized laminate sheet is first wound in a roll. The roll is placed in a vacuum metallizing chamber and the metal vapor-deposited on the discharge-treated metal receiving layer surface. The metal film may include titanium, vanadium, chromium, manganese, iron, cobalt, nickel, copper, zinc, aluminum, gold, or palladium, the preferred being aluminum. Metal oxides can also be contemplated, the preferred being aluminum oxide. The metal layer may have a thickness between 5 and 100 nm, preferably between 20 and 80 nm, more preferably between 30 and 60 nm; and an optical density between 1.5 and 5.0, preferably between 2.0 and 4.0, more preferably between 2.2 and 3.2. The metallized film is then tested for oxygen and moisture gas permeability, optical density, metal adhesion, metal appearance and gloss, heat seal performance, tensile properties, thermal dimensional stability, and can be made into a laminate structure.

This invention will be better understood with reference to the following examples, which are intended to illustrate specific embodiments within the overall scope of the invention.

### EXAMPLE 1

A 2-layer coextruded biaxially oriented PLA film was made using sequential orientation on a 1.5 meter wide tenter frame line, including a core layer substantially of Natureworks® 4032D at about 96 wt % of the core layer and dry-blended with about 4 wt % of DuPont Biomax® 120 ethylene-acrylate copolymer. The coextruded heat sealable skin layer comprised substantially of Natureworks® 4060D at about 100 wt % of the skin layer.

The total thickness of this film substrate after biaxial orientation was ca. 80 G or 0.8 mil or 20 μm. The thickness of the respective heat sealable resin layer after biaxial orientation was ca. 6 G (1.5 μm). The thickness of the core layer after biaxial orientation was ca. 74 G (18.5 μm). The skin layer and the core layer were melt coextruded together at about 190° C. −205° C. The 2-layer co-extrudate was passed through a flat die to be cast on a chill drum of 24° C. using an electrostatic pinner at a casting speed of about 6 mpm. The formed cast sheet was passed through a series of heated rolls at 55-65° C. with differential speeds to stretch in the machine direction (MD) at ca. 3.25× stretch ratio and annealed or heat-set at about 40-45° C. and cooled at about 30-40° C. to obtain a uniaxially oriented laminate sheet. The uniaxially oriented sheet was introduced into a tenter at a line speed of about 18-50 mpm and preliminarily heated between 65 and 75° C. This was followed by transverse direction (TD) stretching at ca. 4-6× stretch ratio in the tenter oven at about 75-90° C. and heat-set or annealed to reduce film shrinkage effects at ca. 90-95° C. The resultant biaxially oriented film was subsequently discharge-treated on the skin layer's surface opposite the heat sealable skin layer via corona treatment. The film was then wound up in roll form.

After film-making, the roll was ground into flake form using film sheet grinders with a knife gap of 0.006 inches (0.1524 mm) and a screen size of 0.25 inches (6.35 mm). Flake density produced by this process was about 7 lb/ft³ (0.112 g/cm³). The flake material was then processed into pellets using twin-screw extrusion. A 34 mm counter-rotating twin-screw vacuum-vented extruder was used at extrusion temperature set points of about 175-210° C. Total concentration of the ethylene-acrylate copolymer after processing the film into pellet form was estimated to be about 3.7 wt % of the pellet. After testing a sample for intrinsic viscosity and color, the pellets were reprocessed through the same twin-screw up to at least five extrusion passes and heat histories. Intrinsic viscosity and color samples were taken after each extrusion cycle.

### COMPARATIVE EXAMPLE 1

A process similar to Example 1 was repeated except that the core layer comprised substantially 100 wt % of crystalline 4032D and 0 wt % of ethylene-acrylate copolymer Biomax® 120. Total concentration of the ethylene-acrylate copolymer in the processed pellet was 0 wt %.

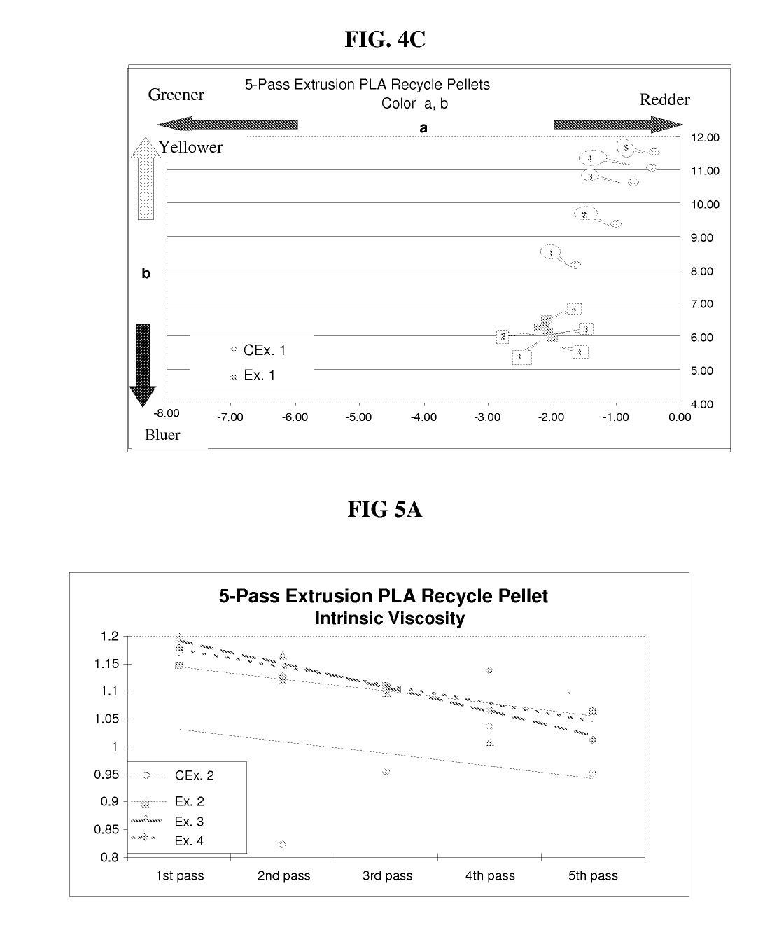

Table 1 and FIGS. 4A, 4B, and 4C illustrate the intrinsic viscosity, color lightness (L), and pellet color properties of Example 1 (“Ex. 1”) and Comparative Example 1 (“CEx. 1”).

TABLE 1

| | Composition | | | | | |
|---|---|---|---|---|---|---|
| | of PLA Resin | Recycle | Intrinsic | | | |
| | Pellet by | Pellet | Viscosity | Color | | |
| | weight | Pass | (IV) | L* | a* | b* |
| CEx. 1 | PLA 4032D | Extrusion | 1.2584 | 65.99 | −1.63 | 8.12 |
| | (92.5%) | Pass 1 | | | | |
| | PLA4060D | Extrusion | 1.2574 | 63.77 | −1.00 | 9.37 |
| | (7.5%) | Pass 2 | | | | |
| | BIOMAX 120 | Extrusion | 1.1871 | 62.38 | −0.72 | 10.59 |
| | (0%) | Pass 3 | | | | |
| | | Extrusion | 1.1697 | 60.13 | −0.43 | 11.05 |
| | | Pass 4 | | | | |
| | | Extrusion | 1.1232 | 60.47 | −0.39 | 11.50 |
| | | Pass 5 | | | | |
| Ex. 1 | PLA 4032D | Extrusion | 1.2985 | 72.40 | −2.05 | 6.12 |
| | (96.5%) | Pass 1 | | | | |
| | PLA 4060D | Extrusion | 1.2965 | 72.84 | −2.18 | 6.26 |
| | (7.5%) | Pass 2 | | | | |
| | BIOMAX 120 | Extrusion | 1.2887 | 72.65 | −2.13 | 6.27 |
| | (3.7%) | Pass 3 | | | | |
| | | Extrusion | 1.2822 | 71.97 | −1.98 | 5.94 |
| | | Pass 4 | | | | |
| | | Extrusion | 1.2772 | 73.38 | −2.07 | 6.50 |
| | | Pass 5 | | | | |

As Table 1 and FIGS. 4A-C show, Comparative Example 1—which contained no ethylene acrylate copolymer—showed a significant change in intrinsic viscosity as successive extrusion passes took place (FIG. 4A). By the third extrusion pass, CEx. 1's formulation showed significant degradation as shown by the rapid decrease in intrinsic viscosity which indicates that the molecular weight of the PLA resin decreased dramatically due to degradation from repeated thermal exposure. Additionally, CE. 1's color also changed significantly with successive extrusion cycles. As shown in FIG. 4B, CEx. 1's pellets darkened with each successive extrusion pass—starting with the second extrusion pass—indicating an increase in degradation products with each pass. In terms of color, CEx. 1 became redder and yellower in color (i.e. more brown) with each successive extrusion pass (FIG. 4C).

In contrast, Example 1—which contained an amount of ethylene acrylate copolymer—showed much different results to this thermal exposure. As shown in Table 1 and graphically in FIG. 4A, the intrinsic viscosity of Ex. 1 holds steadily despite the successive and cumulative heat histories from multiple extrusion passes. Indeed, the change in intrinsic viscosity from the first extrusion pass to the fifth one is 1.64% decrease vs. a decrease of 10.7% for CEx. 1. Thus, Ex. 1 is almost ten times more resistant to thermal degradation than CEx. 1 is in terms of changes to intrinsic viscosity.

Similarly, in terms of color change, Example 1 shows virtually no change in lightness or color by L*a*b* color scale measurement over the five extrusion cycles as shown in FIGS. 4B and 4C. This is indicative that no or very little degradation products are being generated with Example 1 and that the PLA polymer molecules are protected by the ethylene acrylate copolymer from the degradation effects of multiple extrusion heat histories. In contrast, Comparative Example 1—which contained no ethylene acrylate copolymer—showed marked change in lightness and color with successive extrusion passes, indicating degradation of the PLA polymers.

Additional Examples and Comparative Examples were prepared wherein PLA resin blends were produced directly instead of extruded and oriented film samples:

### EXAMPLE 2

A melt-blended pelletized formulation was prepared by compounding about 84.1 wt % Natureworks® 4032D crystalline PLA, about 14.9 wt % Natureworks® 4060D amorphous PLA, and about 1.0 wt % Biomax® 120 ethylene-acrylate copolymer. This formulation was melt-blended together using a twin-screw and vented extruder and pelletized. The pellets were re-processed through the twin-screw extruder for up to five extrusion passes and repelletized after each pass. After each extrusion cycle, the pellets were tested for intrinsic viscosity and color.

### COMPARATIVE EXAMPLE 2

A process similar to Example 2 was repeated except that the amount of 4032D was about 85 wt %, the 4060D was about 15 wt %, and no ethylene-acrylate copolymer was used.

### EXAMPLE 3

A process similar to Example 2 was repeated except that the amount of 4032D was about 83.3 wt %, the amount of 4060D was about 14.7 wt %, and the amount of ethylene-acrylate copolymer was about 2.0 wt %.

### EXAMPLE 4

A process similar to Example 2 was repeated except that the amount of 4032D was about 82.5 wt %, the amount of 4060D was about 14.5 wt %, and the amount of ethylene-acrylate copolymer was about 3.0 wt %.

Table 2 and FIGS. 5A, 5B, and 5C illustrate the properties of Examples 2, 3, 4 (“Ex. 2-4”), and Comparative Example 2 (“CEx. 2”).

TABLE 2

| | Composition | | | | | |
|---|---|---|---|---|---|---|
| | of PLA Resin | Recycle | Intrinsic | | | |
| | Pellet by | Pellet | Viscosity | Color | | |
| | weight | Pass | (IV) | L* | a* | b* |
| CEx. 2 | PLA 4032D | Extrusion | 1.1700 | 66.59 | −1.51 | 7.04 |
| | (85.0%) | Pass 1 | | | | |
| | PLA 4060D | Extrusion | 0.8230 | 64.97 | −1.09 | 8.70 |
| | (15.0%) | Pass 2 | | | | |
| | BIOMAX 120 | Extrusion | 0.9950 | 62.30 | −0.60 | 9.99 |
| | (0%) | Pass 3 | | | | |
| | | Extrusion | 1.0350 | 61.77 | −0.28 | 10.96 |
| | | Pass 4 | | | | |
| | | Extrusion | 0.9520 | 60.67 | −0.25 | 12.30 |
| | | Pass 5 | | | | |
| Ex. 2 | PLA 4032D | Extrusion | 1.1454 | 69.02 | −1.81 | 6.68 |
| | (84.1%) | Pass 1 | | | | |
| | PLA 4060D | Extrusion | 1.1184 | 67.46 | −1.37 | 7.39 |
| | (14.9%) | Pass 2 | | | | |
| | BIOMAX 120 | Extrusion | 1.1100 | 66.69 | −1.09 | 8.38 |
| | (1.0%) | Pass 3 | | | | |
| | | Extrusion | 1.0636 | 65.29 | −0.85 | 9.36 |
| | | Pass 4 | | | | |
| | | Extrusion | 1.0632 | 64.74 | −0.63 | 10.48 |
| | | Pass 5 | | | | |
| Ex. 3 | PLA 4032D | Extrusion | 1.1988 | 70.92 | −1.93 | 5.75 |
| | (83.3%) | Pass 1 | | | | |
| | PLA 4060D | Extrusion | 1.1655 | 70.88 | −1.92 | 6.51 |
| | (14.7%) | Pass 2 | | | | |
| | BIOMAX 120 | Extrusion | 1.0976 | 69.84 | −1.74 | 7.29 |
| | (2.0%) | Pass 3 | | | | |
| | | Extrusion | 1.0079 | 69.52 | −1.67 | 8.02 |
| | | Pass 4 | | | | |
| | | Extrusion | 1.0644 | 68.64 | −1.52 | 8.87 |
| | | Pass 5 | | | | |
| Ex. 4 | PLA 4032D | Extrusion | 1.1795 | 74.78 | −2.18 | 5.62 |
| | (82.5%) | Pass 1 | | | | |
| | PLA 4060D | Extrusion | 1.1262 | 73.58 | −2.17 | 6.04 |
| | (14.5%) | Pass 2 | | | | |
| | BIOMAX 120 | Extrusion | 1.1012 | 72.81 | −2.15 | 6.63 |
| | (3.0%) | Pass 3 | | | | |
| | | Extrusion | 1.138 | 72.79 | −2.14 | 7.03 |
| | | Pass 4 | | | | |
| | | Extrusion | 1.0116 | 72.67 | −2.11 | 7.73 |
| | | Pass 5 | | | | |

As shown in Table 2 and FIGS. 5A-C, similar to Comparative Example 1 described previously, Comparative Example 2 (which is a control PLA resin pellet with 0 wt % ethylene acrylate copolymer added) exhibited severe loss of intrinsic viscosity after several extrusion passes. After five passes, intrinsic viscosity decreased by 18.6%. CEx. 2's color lightness darkened significantly with each extrusion pass and its color also changed significantly towards the red and yellow spectrum (became browner). These data indicated severe degradation of the PLA polymer.

Example 2 with a nominal 1.0 wt % loading of ethylene acrylate copolymer reduced the amount of degradation. Intrinsic viscosity decreased a lesser degree than CEx. 2, at about 7.2%, indicating significantly less degradation than CEx. 2 after 5 passes. Similarly, with L*a*b* color changes, Ex. 2 showed less color change than CEx. 2 after 5 passes.

Example 3 with a higher loading of ethylene acrylate copolymer at about 2.0 wt % also showed significantly improved protection from degradation compared to CEx. 2. Intrinsic viscosity decreased by 11.2% vs. 18.6% for CEx. 3 after 5 passes. With color and lightness changes, Ex. 3 was significantly better than both CEx. 2 and Ex. 2, indicating that a higher loading of ethylene acrylate copolymer helped provide additional protection from thermal degradation.

Example 4 for this experiment had the highest loading of ethylene acrylate copolymer at 3.0 wt %. Intrinsic viscosity decreased by about 14.2%, still better than CEx. 2 at 18.6% loss after 5 passes. However, this Example showed the least amount of color change in terms of lightness and red/yellowing. Lightness L* had almost no change; redness a* had virtually no change, and yellowness b* was the least of this set of Examples.

It was also noted that for these Examples 2-4, after the very first extrusion pass, exhibited significantly higher intrinsic viscosity than Comparative Example 2. Indeed, the intrinsic viscosity trends shown in FIG. 5A for Ex. 2-4 were very similar to each other and basically overlaid each other in retaining intrinsic viscosity compared to CEx 2.

Thus, the addition of only 1.0 wt % of ethylene acrylate copolymer is sufficient to significantly retard the degradation of PLA resins during multiple extrusion cycles such as could be encountered during the recycling and re-processing of PLA films and articles. This can provide significant cost savings in allowing recycled PLA resins to replace costlier virgin PLA resins. Additionally, more protection from degradation can be obtained by higher loadings of ethylene acrylate copolymer, although for cost reasons, it is probably desired to use the least amount necessary. Moreover, by using the minimum amount of ethylene acrylate copolymer loading needed for thermal degradation protection, the biological degradability and compostability of PLA articles are maintained as well as allowing a high percentage of sustainable material content.

Thus, of the foregoing Examples and Comparative Examples, only the inventive Examples which used an amount of modifying ethylene-acrylate copolymer blended with an amount of crystalline polylactic acid polymer in the core base layer was effective in satisfying the requirements of retaining high degree of intrinsic viscosity and minimizing color and lightness changes.

### Test Methods

The various properties in the above examples were measured by the following methods:

Transparency of the film was measured by measuring the haze of a single sheet of film using a hazemeter model like a BYK Gardner “Haze-Gard Plus®” substantially in accordance with ASTM D1003. Preferred values for haze are 10% maximum or lower.

Intrinsic viscosity was measured by first dissolving about 0.1 grams of the sample pellet in a mixture of phenol and tetrachloroethane at 100° C. for 20 minutes. The solution was cooled to 25° C. for 20 minutes and then intrinsic viscosity measured in a Brookfield model DV-E capillary viscometer tube.

Color and lightness L*a*b* was measured by taking about 150-200 grams of the pellets, placing them inside a transparent clear glass cubical container, and inserting the container into a HunterLab Instruments Colorquest® model XE. The glass container is an accessory part of the Colorquest® XE instrument.

Transverse orientation obtained was measured by varying the stretching and outlet zones' chain rail widths in relation to the in-feed rail settings of the transverse direction orientation (TDO) oven section. The comparison in width between inlet and stretch was used to calculate TD orientation ratio obtained. The tenter frame line also had to maintain operability for 20 minutes without film breaks. Adjustments to TDO temperatures were allowed to optimize haze level and operability for each variable.

This application discloses several numerical ranges in the text and figures. The numerical ranges disclosed inherently support any range or value within the disclosed numerical ranges even though a precise range limitation is not stated verbatim in the specification because this invention can be practiced throughout the disclosed numerical ranges.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein. Finally, the entire disclosure of the patents and publications referred in this application are hereby incorporated herein by reference.

What is claimed as new and desired to be protected by Letters Patent of the United States is:

1. A film comprising:
a base layer comprising recycled polylactic acid resin and at least 1 wt % ethylene acrylate copolymer.

2. The film of claim 1, wherein the film contains at least 1 wt % recycled polylactic acid resin.

3. The film of claim 1, wherein the base layer comprises crystalline polylactic acid.

4. The film of claim 3, wherein the base layer further comprises amorphous polylactic acid.

5. The film of claim 1, wherein the film is biaxally oriented.

6. The film of claim 1, wherein the film is transverse oriented 8-11×.

7. A multi-layer film comprising:
a base layer comprising recycled polylactic acid resin and at least 1 wt % ethylene acrylate copolymer; and
a heat sealable layer comprising amorphous polylactic acid on a surface of the base layer.

8. The multi-layer film of claim 7, wherein the heat sealable layer further comprises crystalline polylactic acid.

9. The multi-layer film of claim 7, wherein the heat sealable layer further comprises ethylene acrylate copolymer.

10. The multi-layer film of claim 7, wherein the base layer is discharge treated on a surface opposite the heat sealable layer.

11. The multi-layer film of claim 10, further comprising a metal layer on the discharge treated surface of the base layer.

12. The multi-layer film of claim 7, further comprising a skin layer comprising polylactic acid resin on a surface of the base layer opposite the heat sealable layer.

13. The multi-layer film of claim 12, wherein the skin layer comprises crystalline polylactic acid resin and ethylene acrylate copolymer.

14. The multi-layer film of claim 12, wherein the skin layer is a printing layer, metal receiving layer, or coating receiving layer.

15. The multi-layer film of claim 12, wherein the skin layer is discharge treated on a surface opposite the base layer.

16. The multi-layer film of claim 15, further comprising a metal layer on the discharge treated surface of the skin layer.

17. The multi-layer film of claim 7, wherein the multi-layer film is biaxally oriented.

18. The multi-layer film of claim 7, wherein the multi-layer film is transverse oriented 8-11×.

19. A method of making a film comprising:
extruding a film comprising a base layer comprising recycled polylactic acid resin and at least 1 wt % ethylene acrylate copolymer.

20. The method of claim 19, further comprising:
recycling scrap material from the film; and
re-extruding a layer comprising the recycled scrap material.

21. The method of claim 19, wherein the film contains at least 1 wt % recycled polylactic acid resin.

22. The method of claim 19, wherein the base layer comprises crystalline polylactic acid.

23. The method of claim 19, further comprising biaxally orienting the film.

24. The method of claim of claim 19, further comprising transverse orienting the film 8-11×.

25. A method of making a multi-layer film comprising:
co-extruding a multilayer film comprising a base layer and a heat sealable layer on a surface of the base layer, the base layer comprising recycled polylactic acid resin and at least 1 wt % ethylene acrylate copolymer, and the heat sealable layer comprising amorphous polylactic acid.

26. The method of claim 25, further comprising:
recycling scrap material from the multi-layer film; and
re-extruding a film comprising the recycled scrap material.

27. The method of claim 25, further comprising discharge treating a surface of the base layer opposite the heat sealable layer.

28. The method of claim 27, further comprising applying a metal layer on the discharge treated surface of the base layer.

29. The method of claim 25, further comprising co-extruding a skin layer comprising polylactic acid resin on a surface of the base layer opposite the heat sealable layer.

30. The method of claim 29, wherein the skin layer comprises crystalline polylactic acid resin and ethylene acrylate copolymer.

31. The method of claim 29, further comprising discharge treating a surface of the skin layer opposite the base layer.

32. The method of claim 31, further comprising applying a metal layer on the discharge treated surface of the skin layer.

33. An article comprising:
recycled polylactic acid resin and at least 1 wt % ethylene acrylate copolymer.

34. The article of claim 33, wherein the article contains at least 1 wt % recycled polylactic acid resin.

35. A resin mixture comprising:
a recycled polylactic acid resin and at least 1 wt % ethylene acrylate copolymer.

36. The resin mixture of claim 35, wherein the resin mixture contains at least 1 wt % recycled polylactic acid resin.
